(19) United States
(12) Patent Application Publication
(10) Pub. No.: US 2016/0268066 A1
(43) Pub. Date: Sep. 15, 2016

(54) DOME-SHAPED MOVABLE CONTACT PIECE

(71) Applicant: FUJI ELECTRONIC INDUSTRIES, LTD., Shizuoka-shi (JP)

(72) Inventor: Kunihito SUGIMOTO, Shizuoka-shi (JP)

(21) Appl. No.: 14/849,754

(22) Filed: Sep. 10, 2015

(30) Foreign Application Priority Data
Mar. 11, 2015 (JP) 2015-047864

(51) Int. Cl. H01H 1/06

(52) U.S. Cl. CPC H01H 1/06; H01H 2205/00

(57) ABSTRACT

In a dome-shaped movable contact piece, the durability of the dome-shaped movable contact piece is improved by removing a tearing force at a bent portion during the reverse deformation of a dome-shaped portion to prevent cracks.

The movable contact piece includes an upright outer circumference portion formed in an outer circumference of a trapezoid conductive spring plate and a flat portion. When a dome portion is formed by an arm portion between slits, a position close to the center in relation to a corner portion of the slit is set as a bent line so that the dome portion is formed by the arm portion at the center in relation to the bent line. Accordingly, the dome portion is reversely deformed by using the bent line as a bent position. Thus, it is possible to prevent a tearing force from being applied to the corner portion in a twisted state.

### TECHNICAL FIELD

The present invention relates to a dome-shaped movable contact piece which is used in a switch of an input unit such as a keyboard of a cellular phone or an electronic device, and particularly, to a dome-shaped movable contact piece that acts with a long stroke (a large downward pushing amount) while guaranteeing the durability thereof.

### BACKGROUND ART

Generally, a dome-shaped movable contact piece that acts with a long stroke is obtained by forming an elastic thin metal plate in a dome shape to be reversely returned, and a slit is formed in a dome portion of the dome-shaped movable contact piece. With this structure, the dome-shaped movable contact piece can be reversed by a small downward pushing force.

For example, Patent Document 1 discloses a disc spring for a control valve. Here, a fan-shaped hole is provided at four equal arrangement positions about the center of the disc spring so that a band-shaped spring is formed in a cross shape between the holes. In the disc spring, the band-shaped spring forms a boundary between a spherical surface extending from a circular-arc at the outer periphery of the fan-shaped hole and an outer peripheral portion, and the boundary is set as a bent position during a reverse deformation.

For this reason, a tearing force acts on an acute corner portion of the hole at the base of the band-shaped spring, that is, the bent position during the elastic deformation of the band-shaped spring while the acute corner portion is twisted, and hence a stress is intensively applied to the bent position. As a result, a crack is easily generated in a portion to which a stress is intensively applied. Particularly, the acute corner portion is easily cracked. Thus, there is a disadvantage that the durability is degraded. In addition, this disadvantage will be described in detail later by comparing the invention of FIGS. 3A and 3B with the related art of FIGS. 4A and 4B.

Further, Patent Document 2 discloses a switch spring in which four notches are provided in a body of a disc spring similarly to Patent Document 1. However, the reverse deformation of the body only occurs at the center position so that a portion between the adjacent notches is not bent. Thus, a tearing force is not substantially applied to the portion between the adjacent notches so that a crack is not easily generated at the edge of the notch. As a result, a problem does not arise in which the durability is degraded.

### CITATION LIST

### Patent Documents

Patent Document 1: Japanese Patent Application Laid-Open (JP-A) No. 45-13966

Patent Document 2: Japanese Utility Model Application Laid-Open (JP-U) No. 63-182024

### SUMMARY OF THE INVENTION

### Problem to be Solved by the Invention

Thus, an object of the invention is to improve the durability of the dome-shaped movable contact piece by removing the tearing force at the bent portion during the reverse deformation of the dome-shaped portion to prevent the corner portion of the hole from being cracked while guaranteeing a long stroke in such a dome-shaped movable contact piece.

### Means for Solving Problem

In view of the above-described circumstance, the invention employs a structure in which, when at the arm portion between the plurality of slits, a position located near the center of the dome portion in relation to the corner portion of the slit is set as the bent line of the dome portion, and the dome portion is reversely deformed by using the bent line as a bent position, so that a tearing force is not applied to the corner portion of the slit in a twisted state.

Specifically, according to the invention, provided is a dome-shaped movable contact piece (1) including: a movable contact piece (2) which includes an upright outer circumference portion (3) formed in an outer circumference of a trapezoid conductive spring plate and a flat portion (4) formed in an upper bottom of the trapezoid conductive spring plate, wherein the movable contact piece further includes a plurality of slits (5) which is independently formed about the center of the flat portion (4), a plurality of arm portions (6) each of which is formed between the adjacent slits (5) in a direction from the outer circumference of the flat portion (4) toward the center of the flat portion (4) so that the arm portions are integrated at the center position, a bent line (8) which is formed at a position close to the center in relation to a corner portion (7) at the outer circumference of the slit (5), a dome portion (9) which is curved in a dome shape as a concave surface at a lower bottom of the trapezoid conductive spring plate by all the arm portions (6) at the center in relation to the bent lines (8) and is able to be reversely returned, and a movable contact (10) which is located at the center of the concave surface of the dome portion (9), and wherein the dome portion (9) is reversely deformed by using the bent line (8) as a bent position.

Further, in the invention, the movable contact piece (2) is formed in a truncated cone shape and the arm portions (6) are integrated in a cross shape by the slits (5) disposed at four equal arrangement positions about the center of the flat portion (4).

Furthermore, in the invention, the flat portion (4) is continuous in the entire outer circumferential edge and the corner portion (7) at the outer circumference of the slit (5) is smoothly formed in a curve shape.

### Effect of the Invention

According to the dome-shaped movable contact piece (1) of the invention, since the dome portion (9) is formed by the upright outer circumference portion (3) and the plurality of arm portions (6), it is possible to guarantee a long stroke by a small downward pushing force. Particularly, since the dome portion (9) is bent at the position of the bent line (8) near the center in relation to the corner portion (7) of the slit (5) to be reversely deformed, a tearing force is not applied to the corner portion (7) in a twisted state. Accordingly, a stress is not intensively applied to the corner portion (7), that is, the base of the arm portion (6) so that the generation of the crack is suppressed. As a result, the durability can be improved.

Further, in the dome-shaped movable contact piece (1) of the invention, when the slits (5) are formed at four equal arrangement positions so that the arm portions (6) are integrated in a cross shape, the entire structure or the force balance is satisfactory. Thus, a stable reverse deformation operation may be performed for a long period of time.

Furthermore, in the dome-shaped movable contact piece (1) of the invention, when the flat portion (4) is continuous in the entire outer circumferential edge, the rigidity of the annular ridge portion between the upright outer circumference portion (3) and the flat portion (4) may be improved. Further, when the corner portion (7) at the outer circumference of the slit (5) is formed in a curve shape, the stress is distributed at the smooth curved portion even when a bending force is applied to the curve-shaped corner portion (7) at the position of the bent line (8). As a result, it is possible to reliably suppress a crack compared to the acute corner portion (7).

### BRIEF DESCRIPTION OF DRAWINGS

FIG. 1 is a top view of a dome-shaped movable contact piece of the invention;

FIG. 2 is a cross-sectional view taken along the line A-A of FIG. 1 when the dome-shaped movable contact piece of the invention is assembled to a switch board;

FIGS. 3A and 3B are enlarged view of a main part of the dome-shaped movable contact piece of the invention, where FIG. 3A is a top view and FIG. 3B is a cross-sectional view of a bent portion;

FIGS. 4A and 4B are enlarged view of a main part of a dome-shaped movable contact piece of the related art, where FIG. 4A is a top view and FIG. 4B is a cross-sectional view of a bent portion;

FIG. 5 is a top view of another dome-shaped movable contact piece of the invention; and

FIG. 6 is a top view of still another dome-shaped movable contact piece of the invention.

### MODE(S) FOR CARRYING OUT THE INVENTION

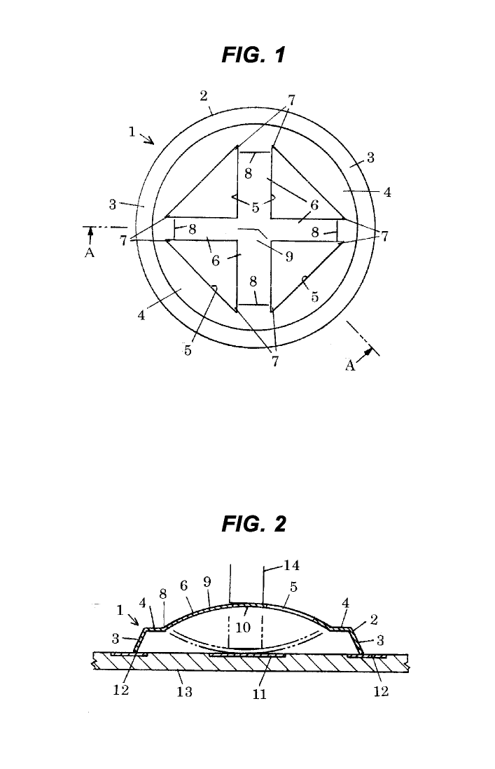

FIGS. 1 and 2 illustrate a structure of a representative dome-shaped movable contact piece 1 of the invention. The dome-shaped movable contact piece 1 includes a movable contact piece 2 that is formed as a conductive thin metal spring plate having a trapezoid shape such as a truncated cone shape. The movable contact piece 2 includes an upright outer circumference portion 3 which is formed in the outer circumference of the trapezoid conductive thin metal spring plate and a flat portion 4 which is formed in an upper bottom of the trapezoid conductive thin metal spring plate. Here, the lower bottom of the trapezoid conductive thin metal spring plate is opened. The height of the upright outer circumference portion 3 is set to a predetermined height in order to guarantee a long stroke. In addition, the spring plate is formed by, for example, a silver or nickel plated stainless rolled steel plate having a plate thickness of about 0.020 to 0.100 mm and an outer diameter of about 3 to 6 mm.

Here, it is assumed that the dome-shaped movable contact piece 1 is formed as the movable contact piece 2. The movable contact piece 2 includes a plurality of (generally four) slits 5 which is formed independently about the center of the flat portion 4, a plurality of arm portions 6 each of which is formed between the adjacent slits 5 in a direction from the slightly inner side of the outer circumference of the flat portion 4 toward the center of the flat portion 4 so that the arm portions are integrated at the center position, a bent line 8 which is formed at a position close to the center in relation to a corner portion 7 of the outer circumference of the slit 5, a dome portion 9 which is curved in a dome shape as a concave surface at the lower bottom of the trapezoid conductive thin metal spring plate by all the arm portions 6 at the center in relation to the bent lines 8 and is able to be reversely returned, and a movable contact 10 which is located at the center of the concave surface of the dome portion 9 and is movable close to or away from a fixed contact 11 of a switch board 13 when the dome portion 9 is reversely deformed. In addition, the dome portion 9 is formed as, for example, a single spherical surface or a complex spherical surface by four arm portions 6.

In the example illustrated in FIG. 1, the slit 5 has an isosceles right triangular shape as an example, and the right angle portion is disposed at four equal arrangement positions about the center in a direction toward the center of the circular flat portion 4. For this reason, the four arm portions 6 are integrated in a cross shape at the center portion of the flat portion 4. The oblique edges of the isosceles right triangular slits 5 are formed slightly near the center from the outer circumference edge of (the ridge between the upright outer circumference portion 3 and the flat portion 4) of the circular flat portion 4. For this reason, the outer circumference end of the arm portion 6, that is, the base of the arm portion 6 is formed near the center from the ridge of the outer circumference of the flat portion 4, and is located between the acute corner portions 7 at the outer circumference of the slit 5. In addition, four arm portions 6 have different widths in this example, but may have the same dimension.

Then, the dome portion 9 forms a curved portion by a portion located near the center in relation to the bent line 8 in the arm portion 6 on the assumption that the bent line 8 close to the center in relation to the acute portion of the corner portion 7 is set as the boundary of the curved portion. Each of the curved surfaces of four arm portions 6, that is, the surface of the dome portion 9 is, for example, a spherical surface. The surface of the dome portion 9 has an appropriate curvature in order to obtain a necessary stroke. Here, the surface of the dome portion 9 is reversely deformed by using the bent line 8 as the bent position when the top portion of the surface is pushed down, and is returned to the original curved shape when the downward pushing operation is stopped.

In addition, the flat portion 4 is continuous in the entire circumference even when the slits 5 are formed, and the upright outer circumference portion 3 and the flat portion 4 form a circular ridge in the entire circumference. For this reason, enough rigidity may be obtained at the ridge portion. Accordingly, a force generated when the arm portion 6 is bent is not transmitted from the arm portion 6 to the upright outer circumference portion 3 or the flat portion 4.

In a production process, the dome-shaped movable contact piece 1 is generally obtained by punching the conductive thin metal spring plate into a final outline shape once. Further, a dome-shaped bending operation is performed before and after a punching step or is performed together with a punching step.

The dome-shaped movable contact piece 1 is assembled to a front surface of the switch board 13 while the concave surface of the dome portion 9 faces the front surface. In the assembled state, a lower end surface of the upright outer circumference portion 3 normally contacts the fixed contact 12 outside the switch board 13. Further, the movable contact 10 at the center of the concave surface of the dome portion 9 faces the fixed contact 11 at the center position of the switch board 13 while being separated therefrom by a predetermined distance. At this time, the fixed contact 11 and the fixed contact 12 are maintained in an electrically non-connected state (an off state).

When an operator pushes the top portion of the dome-shaped movable contact piece 1, that is, the top portion of the dome portion 9 downward by a push part 14 so that the top portion of the dome portion 9 is displaced toward the fixed contact 11, the dome portion 9, that is, each of four arm portions 6 is elastically deformed by using the bent line 8 as a bent position. In this deformation state, the curved direction is reversed under a clicking operation, and a part of the movable contact 10 comes into surface-contact with the fixed contact 11 at the center position. At this time, the fixed contact 11 and the fixed contact 12 are electrically connected to each other (in an electrically connected state) through the dome-shaped movable contact piece 1. Although not illustrated in the drawings, a contact protrusion serving as the movable contact 10 may be formed in the concave surface of the dome portion 9 if necessary. The contact protrusion reliably comes into point-contact with the corresponding fixed contact 11 when a switch is turned on, and hence the electrical connection state therebetween becomes satisfactory.

When the operator weakly pushes the push part 14 down, the movable contact piece 1 is reversed and returned by the elastic force thereof in the return direction, and is separated from the fixed contact 11 to become an off state. In the off state, the distance between the movable contact 10 and the fixed contact 11 at the center position corresponds to the stroke of the dome-shaped movable contact piece 1 (the push part 14) when the switch is turned on or off.

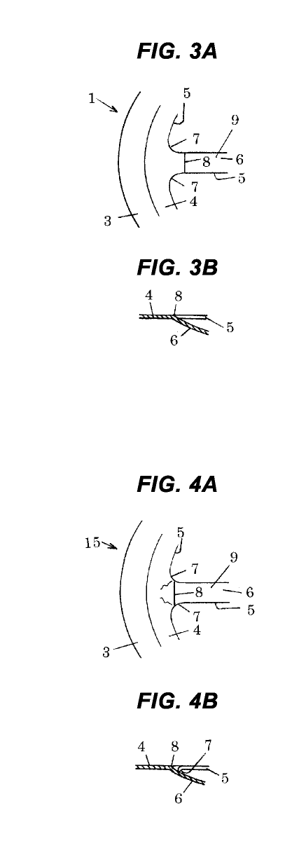

In order to compare the dome-shaped movable contact pieces, FIGS. 3A, 3B and FIGS. 4A, 4B respectively illustrate the dome-shaped movable contact piece 1 of the invention and a dome-shaped movable contact piece 15 of the related art similar to the dome-shaped movable contact piece 1 of the invention in a state where the dome-shaped movable contact piece is bent after the reversing operation. Even in the dome-shaped movable contact piece 15 of the related art, the same name and reference sign are given to the same component as the dome-shaped movable contact piece 1 of the invention from the convenience of comparison.

In FIG. 3A and FIGS. 4A and 4B, the corner portion 7 of the slit 5 at the base position of each arm portion 6 is not formed as the acute corner portion 7 which is easily cracked as illustrated in FIG. 1, but is formed as, for example, the circular-arc (smoothly curved) corner portion 7. The smooth curve is not limited to the circular-arc, but may be formed by a part of an oval or a quadratic curve.

Then, in the dome-shaped movable contact piece 1 of the invention of FIG. 3, the bent line 8 is formed at a position separated from the circular-arc of the circular-arc corner portion 7 so as not to overlap the circular-arc. On the contrary, in the dome-shaped movable contact piece 15 of the related art of FIG. 4, the bent line 8 is formed at a position overlapping the circular-arc while not being separated from the circular-arc of the circular-arc corner portion 7.

As illustrated in FIG. 3A, according to the dome-shaped movable contact piece 1 of the invention, each arm portion 6 is reversely deformed by using the bent line 8 as a bent position when the dome portion 9 is reversely deformed. In the reverse deformation, the bent angle of the bent line 8 has a large angle value in response to a long stroke. Since the bent line 8 at the connection portion between the base of the arm portion 6 and the flat portion 4, that is, the circular-arc corner portion 7 is close to the center, a force acting on the position of the bent line 8 is simply applied in the bending direction when the bent line 8 is bent by a large angle in the reverse deformation of the dome portion 9. As a result, the force is not transmitted to the circular-arc corner portion 7. Thus, a force acting in the tearing direction is not applied to the circular-arc corner portion 7 when the bent line 8 is bent. Consequently, the circular-arc corner portion 7 is not easily cracked, and the connection portion between each arm portion 6 and the flat portion 4 is stable compared to the product of the related art. For this reason, the durability of the dome-shaped movable contact piece 1 is improved. Such a function may be also obtained in the acute corner portion 7 illustrated in FIG. 1.

In addition, even when a downward force is applied to the base of the arm portion 6 during the reverse deformation of the dome portion 9, the base of the arm portion 6 is not bent by a large angle in the reverse deformation, and the circular-arc corner portion 7 distributes the downward force at the circular-arc portion. For this reason, a crack at the position is not easily generated compared to the acute corner portion 7.

On the contrary, when the bent line 8 is located at the base of the arm portion 6 and the line end of the bent line 8 overlaps the circular-arc of the corner portion 7 as illustrated in the related art of FIGS. 4A and 4B, a bending force generated when the bent line 8 is bent by a large angle in accordance with the reverse deformation of the dome portion 9 winds the circular-arc portion of the corner portion 7. Then, the force acts as a tearing force while twisting the end surface of the corner portion 7 and is intensively applied to the corner portion 7. Further, the tearing force acts on both line ends of the bent line 8. For this reason, the corner portion 7 is easily cracked. As a result, there is a tendency that the durability of the connection portion between each arm portion 6 and the flat portion 4 is noticeably degraded.

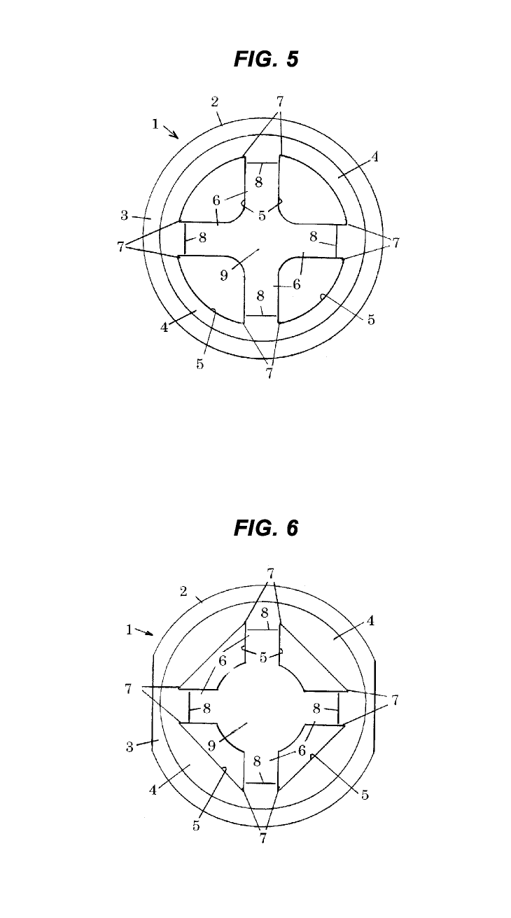

Next, FIG. 5 is an example in which the top corner portion of the slit 5 is formed in a circular-arc shape and four arm portions 6 have the same width dimensions in order to distribute the stress at the center position of the dome portion 9. Further, FIG. 6 is an example in which the slit 5 is formed in a substantially trapezoid shape, a substantially circular wide portion is formed at the center position of four arm portions 6, and the opposite edges of the upright outer circumference portion 3 are formed in a linear plane shape or the opposite edges of the upright outer circumference portion 3 are cut down in a linear shape in response to the size of the assembling space so that the movable contact piece 2 is formed in a substantially oval or gold coin trapezoid shape. Even in these examples, since the bent line 8 of the dome portion 9 is close to the center in relation to the corner portion 7 at the outer circumference of the slit 5, it is possible to prevent a crack generated in the base of the arm portion 6 in advance as in the above-described example.

As described above, in the dome-shaped movable contact piece 1 of the invention, the upright outer circumference portion 3 is provided to guarantee a long stroke. At the same time, an annular ridge is formed in the entire circumference along with the flat portion 4 to give enough rigidity to the arm portion 6 between the adjacent slits 5, that is, the base of the arm portion 6. For this reason, even when the dome portion 9 formed by the plurality of arm portions 6 is reversely deformed by a long stroke at the bent line 8 by the upright state of the upright outer circumference portion 3 and the curved state of the plurality of arm portions 6, the flat portion 4, particularly, the outer circumferential edge of the bent line 8 is not substantially deformed in the stroke direction due to the enough rigidity of the base of the arm portion 6 during the reverse deformation of the dome portion 9. Further, since the downward pushing force for the reverse deformation of the dome portion 9 is a force of deforming the plurality of arm portions 6 in the narrow width between the adjacent slits 5, the force is smaller than a case where the plurality of slits 5 is not provided. Thus, a structure in which the annular ridge exists between the upright outer circumference portion 3 and the flat portion 4 and the dome portion 9 is formed by the plurality of arm portions 6 each having a narrow width and formed toward the center by using the position of the bent line 8 as a boundary is not the simple combination of the related art from the viewpoint of the function of guaranteeing a long stroke, giving rigidity to the flat portion 4, particularly, the outer circumference of the bent line 8, preventing a crack in the corner portion 7, and reversely deforming the dome portion 9 at the center in relation to the bent line 8 by a small force. Thus, the structure is a reliably organic combination structure.

### INDUSTRIAL APPLICABILITY

The dome-shaped movable contact piece 1 of the invention may be also used as switches arranged in a keyboard other than single switch.

### EXPLANATIONS OF LETTERS OR NUMERALS

1 DOME-SHAPED MOVABLE CONTACT PIECE
2 MOVABLE CONTACT PIECE
3 UPRIGHT OUTER CIRCUMFERENCE PORTION
4 FLAT PORTION
5 SLIT
6 ARM PORTION
7 CORNER PORTION
8 BENT LINE
9 DOME PORTION
10 MOVABLE CONTACT
11 FIXED CONTACT
12 FIXED CONTACT
13 SWITCH BOARD
14 PUSH PART
15 DOME-SHAPED MOVABLE CONTACT PIECE OF RELATED ART

1. A dome-shaped movable contact piece (1) comprising:
a movable contact piece (2) which includes an upright outer circumference portion (3) formed in an outer circumference of a trapezoid conductive spring plate and a flat portion (4) formed in an upper bottom of the trapezoid conductive spring plate,
wherein the movable contact piece further includes
a plurality of slits (5) which is independently formed about the center of the flat portion (4),
a plurality of arm portions (6) each of which is formed between the adjacent slits (5) in a direction from the outer circumference of the flat portion (4) toward the center of the flat portion (4) so that the arm portions are integrated at the center position,
a bent line (8) which is formed at a position close to the center in relation to a corner portion (7) at the outer circumference of the slit (5),
a dome portion (9) which is curved in a dome shape as a concave surface at a lower bottom of the trapezoid conductive spring plate by all the arm portions (6) at the center in relation to the bent lines (8) and is able to be reversely returned, and
a movable contact (10) which is located at the center of the concave surface of the dome portion (9), and
wherein the dome portion (9) is reversely deformed by using the bent line (8) as a bent position.

2. The dome-shaped movable contact piece (1) according to claim 1,
wherein the movable contact piece (2) is formed in a truncated cone shape and the arm portions (6) are integrated in a cross shape by the slits (5) disposed at four equal arrangement positions about the center of the flat portion (4).

3. The dome-shaped movable contact piece (1) according to claim 1,
wherein the flat portion (4) is continuous in the entire outer circumferential edge.

4. The dome-shaped movable contact piece (1) according to claim 1,
wherein the corner portion (7) at the outer circumference of the slit (5) is smoothly formed in a curve shape.
